(19) United States
(12) Patent Application Publication
(10) Pub. No.: US 2011/0272396 A1
(43) Pub. Date: Nov. 10, 2011

(54) PLATE MATERIAL AND METHOD FOR MANUFACTURING A PLATE MATERIAL

(75) Inventors: Miguel Angel Buñuel Magdalena, Zaragoza (ES); Francisco Javier Ester Sola, Zaragoza (ES); Antonio José Garcia Herrer, Zaragoza (ES); Jose-Ramon Garcia Jimenez, Zaragoza (ES); Rosa Isabel Merino Rubio, Zaragoza (ES); Fernando Planas Layunta, Zaragoza (ES); Rene Schmalenstrot, Zaragoza (ES)

(73) Assignee: BSH BOSCH UND SIEMENS HAUSGERAETE GMBH, Munich (DE)

(21) Appl. No.: 13/122,795

(22) PCT Filed: Oct. 16, 2009
(86) PCT No.: PCT/EP09/63535

§ 371 Date: May 31, 2011

(30) Foreign Application Priority Data
Oct. 17, 2008 (ES) P200803070

(51) Int. Cl. H05B 6/12; B32B 3/26; B32B 3/00; C09J 7/02; B32B 19/00; B32B 17/06

(52) U.S. Cl. 219/622; 428/688; 428/426; 428/221; 428/337; 428/195.1; 428/304.4

(57) ABSTRACT

A plate material is provided that has a base material and a coating. The base material is a pressed material made from a ceramic matrix and stiffening fibers.

The invention is based on a plate material, in particular a cooktop cover plate, consisting of a base material and at least one coating. The invention further relates to a method for manufacturing such a plate material.

A plate material for manufacturing a cover plate for an induction cooktop is known from EP 0819366 B1, consisting of a base material and a coating. The base material consists of a ceramic that is not further specified and various possible materials are proposed for the coating. In one exemplary embodiment in EP 0819366 B1 it is proposed that the coating should be made from a material stiffened with glass fibers.

Cover plates for cooktops are generally made of a glass ceramic material that is very complex to manufacture. In applications for household appliances in particular the plate material must be temperature-resistant up to at least 700° C. and have good cleaning properties resulting from a robust and smooth surface. The high thermal conductivity of such glass ceramic plates can be advantageous when they are used as cover plates for cooktops with radiant elements. However when they are used as cover plates for induction cooktops the heat of the cooking utensil element placed on the cover plate and heated by the inductors is transferred to the electronic system beneath the glass ceramic plate, which is generally undesirable and disadvantageous. The use of known glass ceramic plates from radiant cooktops for covering induction cooktops is therefore much less advantageous than it first appears.

The object of the invention is therefore in particular to provide a lightweight, stable and temperature-resistant plate material with improved properties in particular when used in induction cooktops.

The object is achieved by a plate material and a method for manufacturing such a plate material according to the independent claims. Advantageous developments of the invention will emerge from the subclaims.

The invention is based on a plate material, in particular a cooktop cover plate. The plate material consists of a base material and at least one coating.

In order to be able to provide a low-cost, lightweight, stable, temperature-resistant and/or effectively thermally insulating plate material, it is proposed that the base material should be configured as a pressed material made from a ceramic matrix and stiffening fibers. The stiffening of the fibers allows a high level of stability to be achieved even if the thickness of the base material is relatively small and the criterion of low thermal expansion that is particularly important for cooktops can be achieved in a simple manner by using the matrix with the stiffening fibers. As with ceramics, in which the low thermal expansion of the glass fibers absorbs the expansion of the crystalline components, the stiffening fibers of the base material block the expansion of the ceramic matrix. It is thus possible to achieve a stable plate material with a low coefficient of thermal expansion. The cleaning properties and necessary hardness of the surface can be achieved by suitable selection of the plate material coating.

The plate material is multilayered and the base material preferably forms the thickest of the layers. Generic plate materials can be used to manufacture cooktop cover plates, particularly if the thermal expansion is less than 0.3×10⁻⁶ per Kelvin. The Vickers hardness is preferably above 400 HV and the bending strength is preferably above 100 MPa.

The inventive plate material withstands loads, even with very high temperature gradients, without damage and has a high thermal shock resistance. The heterogeneous structure of the base material reduces thermal conductivity, making the plate material particularly suitable for use in induction cooktops.

The material of the ceramic matrix can be for example quartz or silicon dioxide, pure aluminum oxide or alumina or a mixture of such materials with small proportions of other ceramic materials such as calcium oxides or magnesia and/or binding agents. In principle the use of a large plurality of ceramic base materials is possible to manufacture the matrix.

The stiffening fibers are preferably glass fibers, but it is also possible to use polymer fibers such as Kevlar, aramid fibers or the like and ceramic fibers such as for example carbon fibers, mullite or silicon carbide. In one preferred embodiment of the invention the ceramic material is a silicon oxide and/or silicate matrix and the stiffening fibers are glass fibers. A mixture of different fiber types is also possible.

The increase in stability achieved by the stiffening fibers can be maximized if the stiffening fibers at least partially form a fabric that is incorporated in the base material.

Experiments have shown that the best properties can be achieved if the thickness of the stiffening fibers is between 6 and 7 μm. The high level of stability of the plate material means that base material thicknesses between 3 and 4 mm are adequate for use in cooktops.

The plate material preferably has a temperature resistance of up to at least 1200° C., which is significantly above the temperature resistance of 700° C. that can be achieved with conventional glass ceramic plates. The person skilled in the art knows that to achieve the required temperature resistance it is necessary in particular to avoid less temperature-resistant coatings.

In one particularly low-cost embodiment of the invention the base material can be a cold-pressed material. However base materials manufactured using a hot-pressing method can also be used.

The cleaning properties of the surface and the hardness of the surface can be improved or increased if the coating comprises a glaze. Glass-type and ceramic glazes are possible. The glazes can eliminate the surface porosity of the base material and increase the hardness of the surface. This allows the service life of the plate material to be lengthened and improves cleaning properties. The use of glazes, which can also be brightly colored, additionally opens up new design possibilities. The advantages resulting from more flexible design come to bear in particular when the inventive plate materials are used in visible regions of household appliances, in particular as a cover plate for cooktops. The glaze can also be applied in particular in the form of surface markings. The surface markings can visualize for example different heating zones of the cooktop, contain information relating to a user interface and/or represent a brand.

In a further embodiment of the invention it is proposed that the coating should comprise a glaze and a screen-printed layer with surface markings applied between the glaze and the base material. The screen-printed layer can advantageously be protected by the in particular transparent glaze, so that it does not demonstrate wear even when a cooktop covered with the inventive plate material is used intensively.

The formation of dust in an interior covered by the plate material due to the crumbling away of the material of the ceramic matrix or small parts of the stiffening fibers breaking off can be avoided if the plate material is coated on both sides.

The thermal conductivity of the plate material can be reduced compared with glass ceramic plates, if the plate material is porous. The advantages of such porosity come to bear particularly when the plate material is used in induction cooktops.

In one development of the invention it is proposed that the plate material should additionally comprise a ferromagnetic layer. The layer can consist in particular of graphite. The graphite layer can be disposed between a base material and a silicon carbide coating and can allow inductive heating of the plate material, while the base material suppresses the transfer of heat in one direction.

The plate material thus manufactured can be used for example to manufacture oven muffles, which can also be employed in industrial applications, such as for example kilns or enameling ovens.

Further advantages will emerge from the description of the drawing which follows. The drawing shows exemplary embodiments of the invention. The drawing, description and claims contain numerous features in combination. The person skilled in the art will expediently also consider the features individually and combine them in useful further combinations.

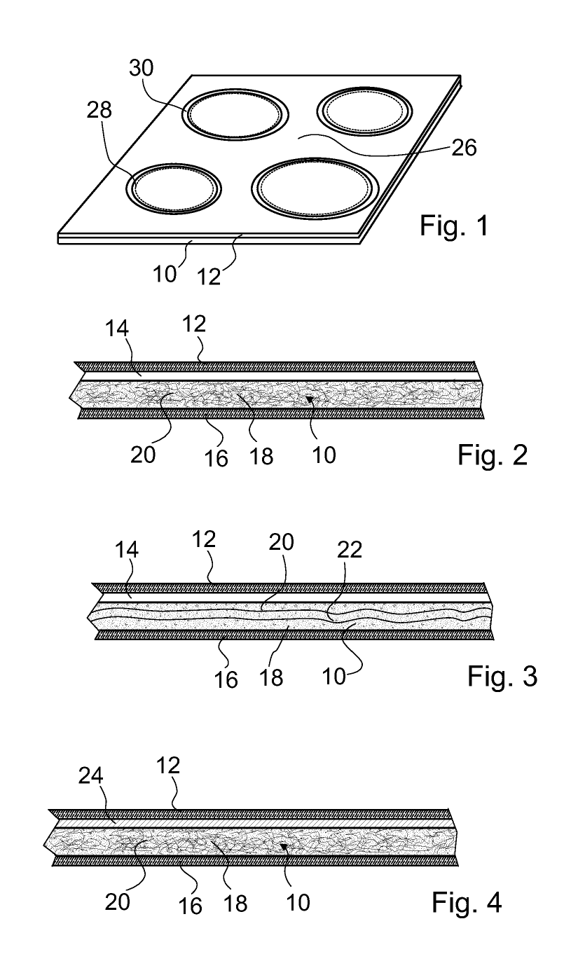

FIG. 1 shows a cooktop with a cover plate made of a plate material,

FIG. 2 shows a layered structure of the plate material of the cover plate from FIG. 1 with a base material and a number of coatings,

FIG. 3 shows a layered structure of a plate material according to a further embodiment of the invention,

FIG. 4 shows a layered structure of a plate material according to a further embodiment of the invention with a ferromagnetic layer,

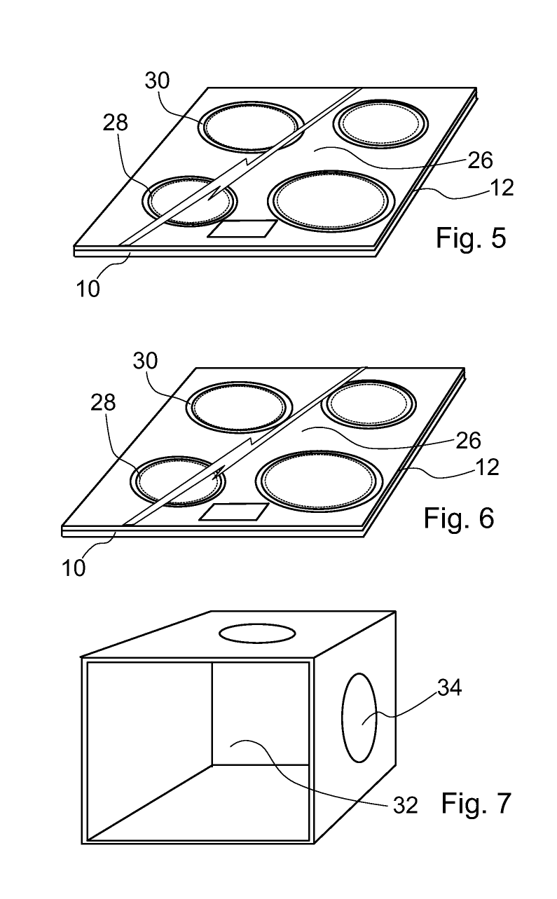

FIG. 5 shows a cover plate for a cooktop according to a further embodiment of the invention with a screen-printed layer marking surfaces,

FIG. 6 shows a cover plate made of a plate material according to a further embodiment of the invention with a glaze applied in the form of surface markings and

FIG. 7 shows a schematic diagram of an oven muffle made of an inventive plate material.

FIG. 1 shows a schematic diagram of a cooktop with a cover plate 26 made of a plate material. The cover plate 26 features a coated top face for holding cooking utensil elements, which is smooth and easy to clean, and a rear face (not shown), in direct proximity to which induction heating elements 28 are disposed for heating cooking utensil elements positioned on the cover plate 26. The inventive cover plate 26 can be employed with a plurality of small inductors disposed in a grid for use in induction cooktops with a conventional hob configuration and also for induction cooktops of the matrix or micromodule type. Use in cooktops with radiant elements is also possible.

FIG. 2 shows a sectional diagram of the plate material of the cover plate 26 from FIG. 1, illustrating the layered structure of the plate material. The plate material consists of a base material 10 and a number of coatings 12, 14, 16. The orientation shown in FIG. 2 corresponds to the orientation of the cover plate 26 in the operating state. The coating 12 forms the horizontally aligned top face of the cooktop and the coating 16 forms the rear face of the cooktop.

As illustrated schematically in FIG. 2, the base material 10 consists of a ceramic matrix 18 and stiffening fibers 20 combined in a homogeneous manner with the material of the matrix 18. The base material 10 is a pressed material manufactured using a cold-pressing method. To manufacture the base material 10, the material forming the ceramic matrix 18 is combined with the stiffening fibers 20 and pressed at very high pressure to form a plate.

In one preferred exemplary embodiment the material of the matrix 18 is a pure quartz powder, which is melted on and/or bound by added binding agents by means of the pressure and in some instances the action of the temperature. In this process a glass-type phase can result for example in microscopic or nanoscopic regions at grain boundaries of the quartz powder microcrystals, producing binding and a generally ceramic structure of the matrix 18.

The resulting base material 10 is stiffened by stiffening fibers 20. In the preferred exemplary embodiment the stiffening fibers 20 are glass fibers. Without these stiffening fibers 20 the material of the matrix 18 would be very soft and brittle, having a chalk-type or limestone-type consistency for example. However the stiffening fibers 20 give the base material 10 a high level of bending strength and breaking strength when forces act on large areas, i.e. with contact surfaces of several square millimeters, of the material.

In alternative exemplary embodiments the stiffening fibers 20 are polymer fibers, for example Teflon or aramid. In further exemplary embodiments the stiffening fibers 20 are carbon fibers, mullite or silicon carbide. In preferred exemplary embodiments the stiffening fibers 20 are glass fibers. Combinations of these fibers are also possible. To manufacture the matrix 18 a small proportion of other ceramic materials can be mixed with the quartz. It is also conceivable for the matrix 18 to be manufactured from pure aluminum oxide/alumina or alumina with other ceramic materials mixed in.

The coating 14 applied directly to the base material 10 is a screen-printed layer, which forms surface markings 30 of the cover plate 26. The screen-printed layer 14 is protected by a coating 12 formed by a glaze. The glaze 12 is in the manner of glass and transparent so that the screen-printed layer 14 and, in regions without a screen-printed layer 14, the base material 10 remain visible to the user from the top face of the cover plate 26.

The stiffening fibers 20 in the base material 10 are as long as possible and have a thickness of 6 to 7 μm. The thickness of the base material is between 3 and 4 mm, the thickness of the screen-printed layer 14 is between 50 and 100 μm and the thickness of the glaze 12 is between 50 and 200 μm. The cover plate 26 and/or the base material 10 is additionally provided with a further coating 16 on the rear face and this is likewise a glaze. This seals the porosity of the rear face of the base material 10 and the porosity of the upper face of the base material 10 and allows the crumbling away of loose particles of the base material 10, which is brittle on a microscopic scale, into the space beneath the cover plate 26, which houses the electronic system of the cooktop, to be avoided.

The base material 10 is essentially white or light gray and opaque, so that a completely novel appearance and new possibilities for the design of the cooktop result from the screen-printed layer 14, which can be applied in all conceivable colors, together with the glaze 12.

The base material 10 has a very high level of porosity with microporous or mesoporous pores of several nanometers in size. This greatly reduces the thermal conductivity of the base material 10, so that hot cooking utensil elements on the cover plate 26 do not readily heat the electronic system disposed beneath the cover plate 26. Appropriate selection of the pressure exerted during the manufacture of the base material using the cold-pressing method allows optimum setting of the pore size. Experiments have shown that a porosity of approximately 30% or in a region between 20% and 40% produces a very satisfactory result.

FIG. 3 shows an alternative exemplary embodiment of the invention, in which the stiffening fibers 20 are not combined with the base material 10 but form a fabric 22, which is incorporated in the matrix 18 made of ceramic silicon dioxide.

The fabric 22 can be supplemented by stiffening fibers combined loosely with the matrix material. One or more fabric layers can be incorporated in the plate material. If at least one fabric layer is incorporated in the plate material in direct proximity to a surface, the surface strength can be further improved.

FIG. 4 shows a further alternative exemplary embodiment of the invention, in which the base material 10 consisting of a ceramic matrix 18 and stiffening fibers 20 is coated with a ferromagnetic layer 24, in particular made of graphite. The base material 10 is porous and comprises air inclusions, which greatly reduce the thermal conductivity of the base material 10. The ferromagnetic layer 24 is protected by a coating 12 made of silicon carbide.

The ferromagnetic layer 24 from FIG. 4 can be heated inductively from a rear face (at the bottom in FIG. 4). Therefore the plate material according to FIG. 4 can advantageously be used to manufacture an oven muffle 32, with the coating 21 facing an interior of the oven muffle 32 and the base material 10 insulating the oven muffle 32 externally (see FIG. 7).

FIG. 5 shows an inventive cover plate 26 of an induction cooktop with surface markings 30, which are protected by a glaze 12. The surface markings 30 are configured as a screen-printed layer and can be embodied in any color or even in a number of colors.

FIG. 6 shows a further alternative exemplary embodiment of the invention, in which the surface markings 30 are part of a coating 14 (FIG. 2), which is configured as a colored glaze. This colored glaze is protected by a second, transparent glaze, which forms a coating 12.

FIG. 7 shows an oven muffle 32 for a furnace or kiln, for example for an industrial enameling kiln, in which the walls of the oven muffle 32 are manufactured from the inventive plate material according to the exemplary embodiment from FIG. 4, provided with a ferromagnetic layer 24 made of graphite.

Disposed outside the oven muffle 32 are inductors 34, which heat the ferromagnetic layer 24 (FIG. 4) from the outside. Heating elements within the muffle 32 can be avoided, thereby significantly improving cleaning properties. Compared with radiant elements disposed outside the oven muffle 32 and a muffle made of metal it is possible to reduce the overall weight considerably and improve efficiency.

### REFERENCE CHARACTERS

10 Base material
12 Coating
14 Coating
16 Coating
18 Matrix
20 Stiffening fibers
22 Fabric
24 Layer
26 Cover plate
28 Induction heating element
30 Surface marking
32 Oven muffle
34 Inductor
D Thickness

1-15. (canceled)

16. A plate material, comprising:
a base material; and
a coating;
wherein the base material is a pressed material made from a ceramic matrix and stiffening fibers.

17. The plate material of claim 16, wherein the plate material is a cooktop cover plate.

18. The plate material of claim 16, wherein the stiffening fibers include glass fibers.

19. The plate material of claim 16, wherein the stiffening fibers form at least partially a fabric.

20. The plate material of claim 16, wherein a thickness of the base material is between 3 mm and 4 mm.

21. The plate material of claim 16, wherein the ceramic matrix is formed essentially from polycrystalline quartz.

22. The plate material of claim 16, wherein the plate material has a temperature resistance up to at least 1200° C.

23. The plate material of claim 16, wherein the base material is a cold-pressed material.

24. The plate material of claim 16, wherein the coating includes a glaze.

25. The plate material of claim 16, wherein the coating includes a glaze that is applied in the form of surface markings.

26. The plate material of claim 16, wherein the coating includes a glaze and a screen-printed layer with surface markings that is applied between the glaze and the base material.

27. The plate material of claim 16, wherein the plate material has coatings on both sides of the plate material.

28. The plate material of claim 16, wherein the base material is porous and wherein a porosity of the base material is between 20% and 35%.

29. The plate material of claim 16, wherein the plate material has a ferromagnetic layer for inductive heating of the plate material.

30. A cooktop, comprising a cover plate made of a plate material, the plate material having a base material and a coating, wherein the base material is a pressed material made from a ceramic matrix and stiffening fibers.

31. A method for manufacturing a plate material, the method comprising:
applying a coating to a base material, wherein the base material is made from a ceramic matrix and stiffening fibers by one of cold-pressing and hot-pressing.

32. The method of claim 31, wherein the plate material is utilized in a cooktop cover plate
